(19) United States
(12) Patent Application Publication
(10) Pub. No.: US 2014/0169738 A1
(43) Pub. Date: Jun. 19, 2014

(54) WAVEGUIDE LENS AND METHOD FOR MANUFACTURING SAME

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/736,946

(22) Filed: Jan. 9, 2013

(30) Foreign Application Priority Data
Dec. 14, 2012 (TW) 101147563

(51) Int. Cl. G02B 6/34

(52) U.S. Cl. CPC G02B 6/34
USPC 385/37; 216/26

(57) ABSTRACT

A method for manufacturing a waveguide lens is provided. A substrate is provided. The substrate includes a top surface and a side surface. A planar waveguide is formed in the top surface. A mask is formed on the planar waveguide. The substrate is subjected to a wet etching process to remove portions of a layer of the planar waveguide which are revealed by the mask to form a media grating identical to the mask in shape in the planar waveguide. Another wet etching process is further applied to remove the mask to form the waveguide lens.

### BACKGROUND

1. Technical Field

The present disclosure relates to integrated optics, and particularly to a waveguide lens and a method for manufacturing the same.

2. Description of Related Art

Lasers are used as light sources in integrated optics as the lasers have excellent directionality, as compared to other light sources. However, laser beams emitted by the lasers do still have a divergence angle. As such, if the laser is directly connected to an optical element, divergent rays may not be able to enter into the optical element, decreasing light usage.

Therefore, it is desirable to provide a waveguide lens, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a waveguide lens, according to an embodiment.

FIG. 2 is a cross-sectional view taken along a line II-II of FIG. 1.

FIG. 3 is a schematic view of a media grating of the waveguide lens of FIG. 1.

FIG. 4 is a schematic view showing a method for manufacturing the waveguide lens, according to another embodiment.

### DETAILED DESCRIPTION

Embodiments of the present disclosure will be described with reference to the drawings.

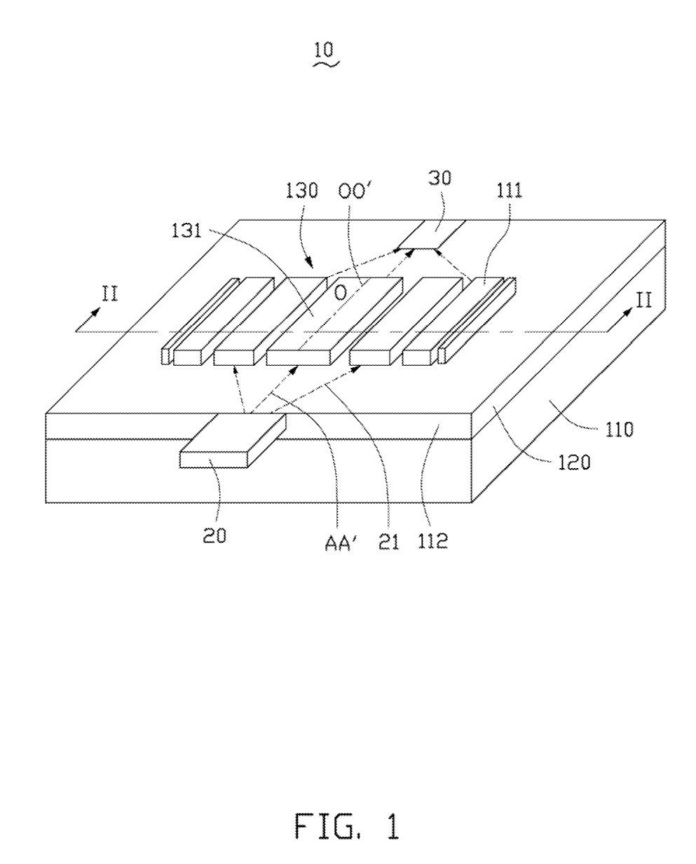

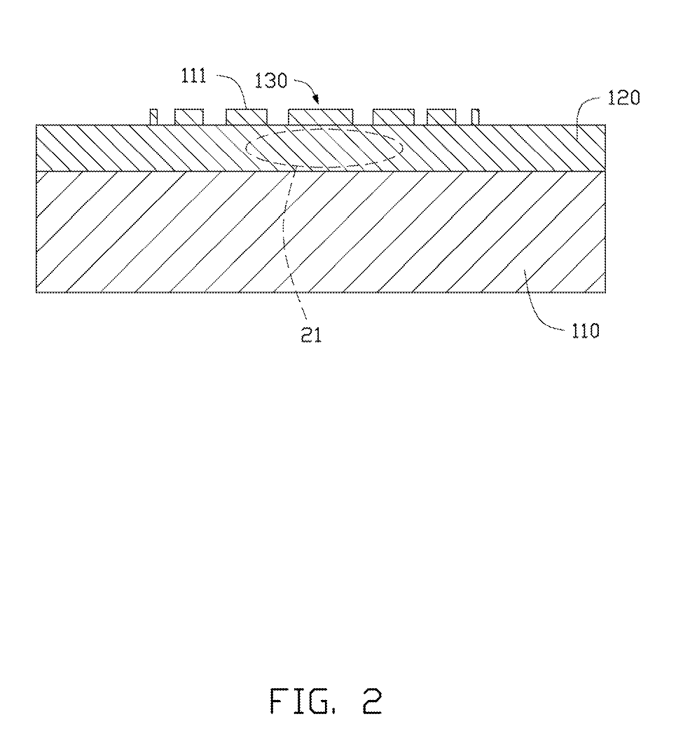

Referring to FIGS. 1-2, a waveguide lens 10, according to an embodiment, includes a substrate 110, a planar waveguide 120 formed on the substrate 110, and a media grating 130 formed on the planar waveguide 120. The planar waveguide 120 is coupled to a laser light source 20 which emits a laser beam 21 having a divergent angle into the planar waveguide 120. The media grating 130 is arranged along a direction that is substantially parallel with an optical axis AA′ of the laser beam 21. The media grating 130 and the planar waveguide 120 constitute a diffractive waveguide lens to converge the laser beam 21 into an optical element 30.

In detail, the media grating 130 includes a number of media strips 131. Each media strip 131 and the planar waveguide 120 cooperatively form a strip-loaded waveguide. An effective refractive index of a portion of the planar waveguide 120 where each media strip 131 is loaded (i.e., a portion of the planar waveguide 120 beneath each media strip 131) increases through the succession of media strips 131. As such, by properly constructing the media grating 130, for example, constructing the media grating 130 as a chirped grating, the media grating 130 and the planar waveguide 120 can function as, e.g., a chirped diffractive waveguide lens.

The substrate 110 is substantially rectangular and includes a top surface 111 and a side surface 112 perpendicularly connecting the top surface 111. In this embodiment, the substrate 110 is made of lithium niobate (LiNbO₃) crystal.

The planar waveguide 120 is formed by coating a film of titanium (Ti) on the top surface 111 and then diffusing the Ti into the top surface 111 by a high temperature diffusion technology. That is, the planar waveguide 120 is made of Ti diffused with LiNbO₃ (Ti:LiNbO₃), of which the effective refractive index gradually changes along a direction perpendicular to the media strips 131 and the top surface 111, creating the benefit of a diffractive waveguide lens. After the planar waveguide 120 is formed, the top surface 111 becomes the upper surface of the planar waveguide 120.

The media grating 130, such as a chirped grating, is formed by etching the upper surface of the planar waveguide 120 (i.e., the top surface 111). That is, the media grating 130 is also made of Ti:LiNbO₃. After the media grating 130 is formed, the top surface 111 is the upper surface of the media grating 130. There are an odd number of the media strips 131. The media strips 131 are symmetrical about a widthwise central axis OO′ of the media grating 130. Each of the media strips 131 is rectangular and parallel with each other. In order from the widthwise central axis OO′ to each side, widths of the media strips 131 decreases, and widths of gaps between each two adjacent media strips 131 also decreases.

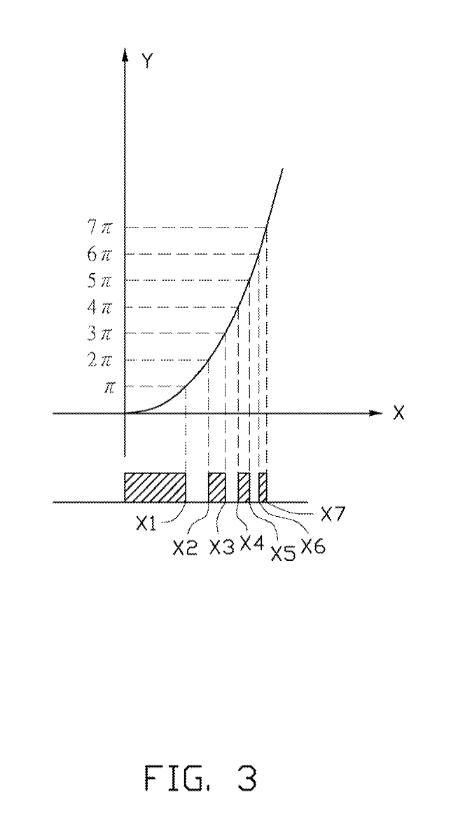

Referring to FIG. 3, a coordinate system “oxy” is established, wherein the origin “o” is an intersecting point of the widthwise central axis OO′ and a widthwise direction of the planar waveguide 120, “x” axis is the widthwise direction of the planar waveguide 120, and “y” axis is a phase shift of the laser beam 21 at a point “x”. According to wave theory of planar waveguides, y=a(1−e^{kx}^{²}), wherein x>0, a, e, and k are constants. In this embodiment, boundaries of the media strips 131 are set to conform to conditions of formulae: yₙ=a(1−e^{kx}ₙ²) and yₙ=nπ, wherein xₙ is the nth boundary of the media strips 131 along the “x” axis, and yₙ is the corresponding phase shift. That is,

$${x}_{n} = \sqrt{\frac{ln ( 1 - \frac{n π}{a} )}{k}}$$

$$( {x}_{n} > 0 ) .$$

The boundaries of the media strips 131 where xₙ<0 can be determined by characteristics of symmetry of the media grating 130.

The laser light source 20 is a distributed feedback laser, and is attached to a portion of the side surface 112 corresponding to the planar waveguide 120. The optical axis AA′ is aligned with the widthwise central axis OO′.

The optical element 30 can be a strip waveguide, an optical fiber, or a splitter.

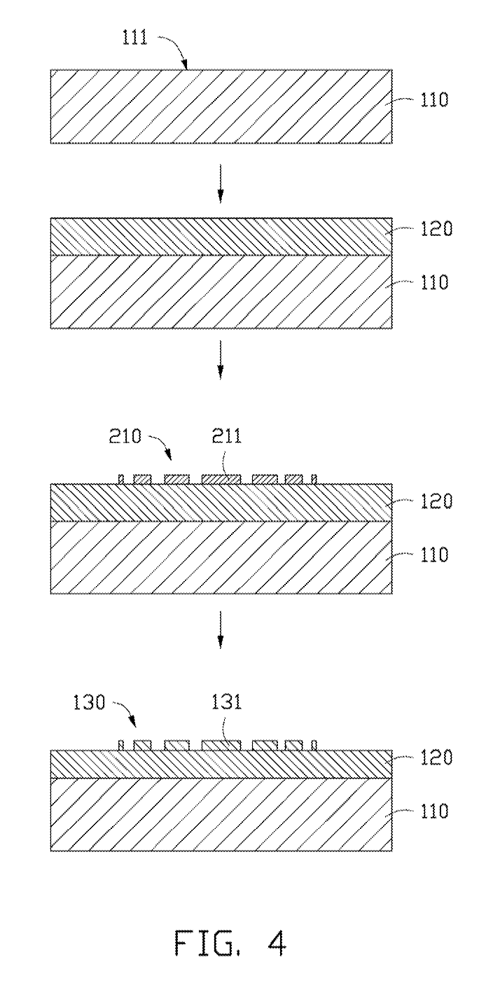

Referring to FIG. 4, a method for manufacturing the waveguide lens 10 is implemented by the following steps S10-S18.

In step S10, the substrate 110 is provided.

In step S12, the planar waveguide 120 is formed in the top surface 111.

In step S14, a mask 210 is formed on the planar waveguide 120. The mask 210 is identical to the media grating 130 in shape and has a number of mask strips 211 corresponding to the media strips 131. The mask 210 is made of chromium (Cr) and formed by, for example, spin coating, exposure, and developing technologies.

In step S16, the substrate 110 having the mask 210 is dipped into a first etching solution to remove portions of a layer of the planar waveguide 120 which is not covered by the mask 210, to form the waveguide lens 10.

In step S18, the waveguide lens 10 having the mask 210 is dipped into a second etching to remove the mask 210.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A waveguide lens, comprising:
a substrate;
a planar waveguide formed on the substrate and used for coupling with a laser light source which emits a laser beam having a divergent angle into the planar waveguide; and
a media grating formed on the planar waveguide and arranged along a direction that is substantially parallel with an optical axis of the laser beam.

2. The waveguide lens of claim 1, wherein the substrate is made of lithium niobate crystal.

3. The waveguide lens of claim 1, wherein the planar waveguide is made of lithium niobate crystal diffused with titanium.

4. The waveguide lens of claim 1, wherein the media grating is made of lithium niobate crystal diffused with titanium.

5. The waveguide lens of claim 1, wherein the substrate is substantially rectangular and comprises a top surface and a side surface perpendicularly connecting the top surface, the planar waveguide and the media grating are formed in the top surface, and the laser light source is attached to a portion of the planar waveguide corresponding to the planar waveguide.

6. The waveguide lens of claim 1, wherein the media grating is a chirped grating.

7. The waveguide lens of claim 1, wherein the media grating comprises a plurality of media strips, the number of the media strips is odd, the media strips are symmetrical about a widthwise central axis of the media grating, each of the media strips is rectangular and parallel with each other, in this order from the widthwise central axis to each widthwise side of the media grating, widths of the media strips decrease, and widths of gaps between each two adjacent media strips also decrease.

8. The waveguide lens of claim 7, wherein a coordinate axis “ox” is established, wherein the origin “o” is an intersecting point of the widthwise central axis and a widthwise direction of the planar waveguide, and “x” axis is the widthwise direction of the planar waveguide, boundaries of the media strips are set to conform condition formulae:
$${x}_{n} = \sqrt{\frac{ln ( 1 - \frac{n π}{a} )}{k}} ,$$
and xₙ>0, wherein xₙ is the nth boundary of the media strips along the “x” axis, and a, e, and k are constants.

9. A method for manufacturing a waveguide lens, the method comprising:
providing a substrate comprising a top surface and a side surface perpendicularly connecting the top surface;
forming a planar waveguide in the top surface;
forming a mask on the planar waveguide;
wet etching the substrate to remove portions of a layer of the planar waveguide which are not covered by the mask to form a media grating identical to the mask in shape in the planar waveguide;
wet etching the mask to remove the mask to form the waveguide lens.

10. The method of claim 9, wherein the planar waveguide is formed by:
coating a film of titanium on the top surface, and
diffusing the titanium into the top surface by a high temperature diffusion technology.
